(19) United States
(12) Patent Application Publication
(10) Pub. No.: US 2013/0080225 A1
(43) Pub. Date: Mar. 28, 2013

(54) Referral Program for Businessess

(71) Applicant: Gokul Rajaram, Los Altos, CA (US)

(72) Inventor: Gokul Rajaram, Los Altos, CA (US)

(21) Appl. No.: 13/247,780

(22) Filed: Sep. 28, 2011

(51) Int. Cl. G06Q 30/02; G06Q 99/00

(52) U.S. Cl. 705/14.16; 705/319

(57) ABSTRACT

In particular embodiments, a user enters a code received at a point of sale identifying a node on a social network representing the point of sale. Upon entering the code into a mobile application, the application requests the user to identify other users that referred the user to the point of sale. Upon selecting one or more referrers, the social networking system applies one or more policies to the selected referrers. In particular embodiments, the social networking system integrates with online merchants, and prompts a user to select users or nodes that referred the user to the site or the specific product. In particular embodiments, the social networking system tracks the value of every single transaction, and may generate a list of the top ten value generators for a given node.

### TECHNICAL FIELD

This disclosure generally relates to providing a referral program for businesses that also maintain a presence on a social networking system, and from the referral program, identifying experts and influencers in the social network and utilizing the identified experts and influencers for advertising, social grouping, and other suitable purposes.

### BACKGROUND

A social network, in general, is a social structure made up of entities, such as individuals or organizations, that are connected by one or more types of interdependency or relationships, such as friendship, kinship, common interest, financial exchange, dislike, or relationships of beliefs, knowledge, or prestige. In more recent years, social networks have taken advantage of the Internet. There are social-networking systems existing on the Internet in the form of social-networking websites. Such social-networking websites enable their members, who are commonly referred to as website users, to perform various social activities. For example, the social-networking website operated by Facebook, Inc. at www.facebook.com enables its users to communicate with their friends via emails, instant messages, or blog postings, organize social events, share photos, receive news of their friends or interesting events, play games, etc.

### SUMMARY

This disclosure generally relates to providing a referral program for businesses maintaining a presence on the social network for the purposes of promotion as well as identifying experts and influencers in a social network and utilizing the identified experts and influencers for advertising, social grouping, and other suitable purposes.

Particular embodiments of the invention permit an application residing on a computing device to receive a code corresponding to a particular node on the social network that represents a particular business. Upon receiving the code, the application may prompt the user of the application to select from a list of his or her first-degree connections, the user or users who referred the user to the particular business.

In particular embodiments, where the merchant is an online merchant, a widget or API may access social graph information hosted by the social networking system, and prompt the user to identify who referred the user to the online merchant or the particular product.

In particular embodiments, the social networking system may then transmit promotional messages to the referrer or referrers, or, in particular embodiments, identify which of the referrers are “expert influencers.”

These and other features, aspects, and advantages of the disclosure are described in more detail below in the detailed description and in conjunction with the following figures.

### BRIEF DESCRIPTION OF THE DRAWINGS

FIG. 1 illustrates an example social networking architecture.

FIG. 2 illustrates an example method for performing a validated user referral.

FIG. 3 illustrates an example user interface on a computing device for performing the method of FIG. 2.

FIG. 4 illustrates an example third-party website implementing the method of FIG. 2.

FIG. 5 illustrates an example method of identifying and ranking top referrers.

FIG. 6 illustrates an example network environment.

FIG. 7 illustrates an example computer system.

FIG. 8 illustrates an example mobile device.

### DESCRIPTION OF EXAMPLE EMBODIMENTS

This disclosure is now described in detail with reference to a few embodiments thereof as illustrated in the accompanying drawings. In the following description, numerous specific details are set forth in order to provide a thorough understanding of this disclosure. However, This disclosure may be practiced without some or all of these specific details. In other instances, well known process steps and/or structures have not been described in detail in order not to unnecessarily obscure This disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

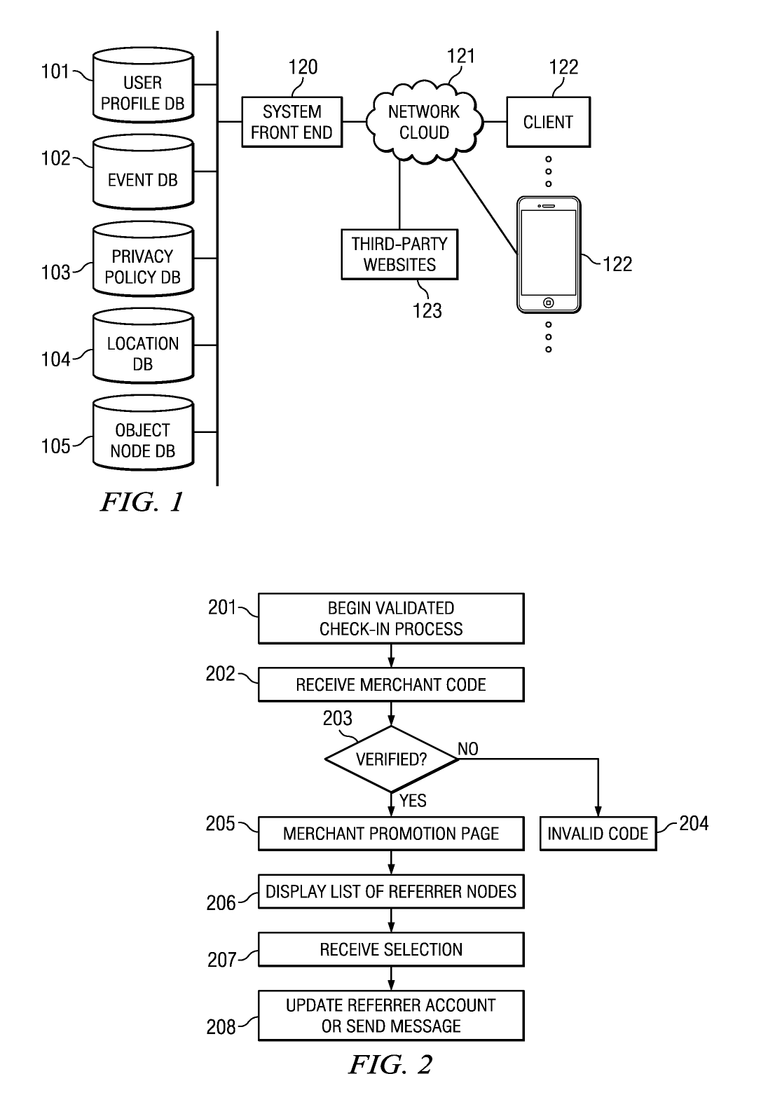

FIG. 1 illustrates an example social networking system. In particular embodiments, the social networking system may store user profile data and social graph information in user profile database 101. In particular embodiments, the social networking system may store user event data in event database 102. For example, a user may register a new event by accessing a client application to define an event name, a time and a location, and cause the newly created event to be stored in event database 102. In particular embodiments, the social networking system may store user privacy policy data in privacy policy database 103. In particular embodiments, the social networking system may store geographic and location data in location database 104. In particular embodiments, databases 101, 102, 103, and 104 may be operably connected to the social networking system's front end. In particular embodiments, the front end 120 may interact with client device 122 through network cloud 121. Client device 122 is generally a computer or computing device including functionality for communicating (e.g., remotely) over a computer network. Client device 122 may be a desktop computer, laptop computer, personal digital assistant (PDA), in- or out-of-car navigation system, smart phone or other cellular or mobile phone, or mobile gaming device, among other suitable computing devices. Client device 122 may execute one or more client applications, such as a web browser (e.g., Microsoft Windows Internet Explorer, Mozilla Firefox, Apple Safari, Google Chrome, and Opera, etc.) or special-purpose client application (e.g., Facebook for iPhone, etc.), to access and view content over a computer network. Front end 120 may include web or HTTP server functionality, as well as other functionality, to allow users to access the social networking system. Network cloud 121 generally represents a network or collection of networks (such as the Internet or a corporate intranet, or a combination of both) over which client devices 122 may access the social network system.

In particular embodiments, location database 104 may store an information base of places, where each place includes a name, a geographic location and meta information (such as the user that initially created the place, reviews, comments, check-in activity data, and the like). Places may be created by administrators of the system and/or created by users of the system. For example, a user may register a new place by accessing a client application to define a place name and provide a geographic location and cause the newly created place to be registered in location database 104. As discussed above, a created place may correspond to a hub node, which an administrator can claim for purposes of augmenting the information about the place and for creating ads or other offers to be delivered to users. In particular embodiments, system front end 120 may construct and serve a web page of a place, as requested by a user. In some embodiments, a web page of a place may include selectable components for a user to “like” the place or check in to the place. In particular embodiments, location database 104 may store geo-location data identifying a real-world geographic location of a user associated with a check-in. For example, a geographic location of an Internet connected computer can be identified by the computer's IP address. For example, a geographic location of a cell phone equipped with cellular, Wi-Fi and/or GPS capabilities can be identified by cell tower triangulation, Wi-Fi positioning, and/or GPS positioning. In particular embodiments, location database 104 may store a geographic location and additional information of a plurality of places. For example, a place can be a local business, a point of interest (e.g., Union Square in San Francisco, Calif.), a college, a city, or a national park. For example, a geographic location of a place (e.g., a local coffee shop) can be an address, a set of geographic coordinates (latitude and longitude), or a reference to another place (e.g., “the coffee shop next to the train station”). For example, a geographic location of a place with a large area (e.g., Yosemite National Park) can be a shape (e.g., a circle, or a polygon) approximating the boundary of the place and/or a centroid of the shape. For example, additional information of a place can be business hours, photos, or user reviews of the place. In particular embodiments, location database 104 may store a user's location data. For example, a user can create a place (e.g., a new restaurant or coffee shop) and the social networking system can store the created place in location database 104. For example, location database 104 may store a user's check-in activities. For example, location database 104 may store a user's geographic location provided by the user's GPS-equipped mobile device. In particular embodiments, the social networking system may calculate one or more routes of a user based on the user's user profile information, check-in activities, and/or geographic location data reported by a client application (see above) and store the one or more routes in location database 104. For example, the social networking system can calculate a “commute route” of a user between the user's home and work (as described in the user's user profile information stored in user profile database 101) by using a mapping service application such as Google Map, or by using geographic location data points from the user's GPS-equipped mobile phone while the user is driving to work. Particular embodiments herein describe methods of automated location check-in for a user based on the user's location data.

A social network system may maintain social graph information, which can generally model the relationships among groups of individuals, and may include relationships ranging from casual acquaintances to close familial bonds. A social network may be represented using a graph structure. Each node of the graph corresponds to a member of the social network. Edges connecting two nodes represent a relationship between two users. In addition, the degree of separation between any two nodes is defined as the minimum number of hops required to traverse the graph from one node to the other. A degree of separation between two users can be considered a measure of relatedness between the two users represented by the nodes in the graph.

In particular embodiments, nodes representing members, businesses, places, or products on a social network may be connected by various types of interdependency or relationships. Each member of a social network is represented as a node, and each connection between two members is represented as an edge linking the two corresponding nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action, such as “purchase,” may be used by a third-party developer on a website external to the social networking system to report custom actions performed by users of the social networking system. In this way, the social graph may be “open,” enabling third-party developers to create and use the custom graph objects and actions on external websites.

In particular embodiments, nodes may represent any entity on the social network. For example, a concept node may exist for a broad generalized concept, such as “basketball.” As another example, a store or chain of stores may be represented by a node on the social network, such as “Sports Authority.” Even more particularly, every single product sold may be represented as a node on the social network; a node may exist for “Nike Air Zoom Kobe IV” shoes. In the aforementioned examples, particular edges may link the concept node “Basketball” to the merchant “Sports Authority” and the product “Nike Air Zoom Kobe IV” shoes. In particular embodiments, the particular location of a “Sports Authority” storefront. In particular embodiments, nodes representing products, businesses, or concepts may be stored in object node db 105. In particular embodiments, the social networking system may dynamically generate object nodes for any given product, business, or concept.

Third-party developers may enable users of the social networking system to express interest in web pages hosted on websites external to the social networking system. These web pages may be represented as page objects in the social networking system as a result of embedding a widget, a social plugin, programmable logic or code snippet into the web pages, such as an iFrame. Any concept that can be embodied in a web page may become a node in the social graph on the social networking system in this manner. As a result, users may interact with many objects external to the social networking system that are relevant to a keyword or keyword phrase, such as “Justin Timberlake.” Each of the interactions with object may be recorded by the social networking system as edges. Enabling third-party developers to define custom object types and custom action types is described further in “Structured Objects and Actions on a Social Networking System,” U.S. application Ser. No. 13/249,340 filed on 21 Sep. 2011, which is hereby incorporated by reference.

In particular embodiments, the social networking system may integrate with third party websites 123 via an application programming interface or script calls to the social networking system servers. In particular embodiments, third party websites 123 may query the social graph using a specialized set of graph protocol functions for any information relating to a particular user, such as which of the user's first-degree connections have also visited third party website 123. In particular embodiments, third party websites 123 may submit information regarding a particular user's purchases or browsing history, and the social networking system may dynamically generate object nodes for the products purchased, or, in particular embodiments, the pages visited. For example, if a user visits page containing a news article and clicks a “share” or “like” widget that communicates with the social networking system, the social networking system may determine whether an object node already exists for the article, and, if not, dynamically create an object node for the article and connect the user node to the object node with a “like” or “share” edge. This disclosure contemplates responding to any type of query to the social graph, and importing any type of object information into the social graph.

FIG. 2 illustrates an example method for a validated user referral process. The process may be executed by, in particular embodiments, a dedicated social networking application residing on a mobile computing device, and performed at the point of sale. In particular embodiments, the method may be performed from a client device visiting the website of the social networking system. In particular embodiments, the method may be performed by a dedicated device at the point of sale. In particular embodiments, it may be performed by a web server operated by the merchant or business. Although the following disclosure describes the embodiment wherein the process is executed on a mobile device, this disclosure contemplates any suitable means of performing the method of FIG. 2.

At Step 201, a user utilizing a mobile device begins a validated check-in process. In particular embodiments, the user may initiate the validated check-in process by initializing a dedicated social networking application residing on a mobile device. For example, when a user makes a purchase at a physical store front, the check-out clerk may ask the user whether is a member of the social networking system, and was referred by anyone, or ask how he or she heard of the store. In response, the user may, at the direction of the clerk or on his own initiative, initialize the social networking application on his or her mobile device.

In order to prevent fraud or abuse, in particular embodiments, the check in must be validated by a merchant code. For example, absent validation, a user may have his or her friends report that the user referred them to a particular merchant, even if none of the friends made any purchases with the merchant, in order to reap the rewards of the referral program. Thus, in particular embodiments, the social networking application first prompts the user to enter a particular code corresponding to the business or merchant's node on the social networking system before permitting the user to proceed. In particular embodiments, the merchant code may be a single string of alphanumeric characters representing the merchant's node on the social networking system. In such embodiments, the merchant may tell the user the code, and the user may enter it himself on the social networking application on his or her mobile device. However, this method is still vulnerable to fraud, as once the user has the code memorized or written down, he may repeat the process, or have others use the code, without having actually purchased anything from the merchant. Thus, in particular embodiments, it may be desirable for the merchant to punch in the code directly. In particular embodiments, the merchant generates a unique, one-time code for each completed transaction in order to prevent re-use or fraud.

In particular embodiments, the code may be displayed on the register, a placard, or preferably, on a receipt issued to the user as a quick response (QR) code, which may be scanned using the camera of a mobile device. In particular embodiments, the code may be delivered via near field communications (NFC). In particular embodiments, the social networking system may deliver the code, at the direction of the merchant, via a social networking message over the Internet. In particular embodiments, the code may emailed or SMS messaged to the user. In particular embodiments, other means may be used to deliver the code to the user, such as Bluetooth low energy (BLE) transmission, radio frequency identification (RFID), 802.11 WiFi and 802.16 WiMax, and the like. This disclosure contemplates any suitable method of generating merchant codes, and any suitable method of delivering the code to the referrer application.

In particular embodiments, the process of FIG. 2 may be integrated with the check-in process as described above. In particular embodiments, the user may enter the code at a later time, such as when posting a status message. In particular embodiments, the social networking application may prompt the user for the code automatically when the user performs a check-in, updates his or her status with text identifying the business, or when the social networking system determines that he or she is at a particular business. For example, based on the mobile device's location information, the social networking system is aware when the user leaves a particular place of business. In such an example, the social networking application on the user's mobile device may prompt the user as he or she leaves a particular location to enter the code and identify a referrer.

At Step 203, the social networking application residing on the user's mobile device attempts to verify the code with the social networking system. In particular embodiments, the mobile device transmits the merchant code to the social networking system, and awaits a verification message from the social networking system. In particular embodiments, the social networking system verifies the code using other information received from the mobile device, such as the mobile device location. For example, if the user is attempting to verify a merchant code for a physical store far from his mobile device's self-reported location, the process may not pass the verification step. This disclosure contemplates any suitable manner of verifying a particular merchant code.

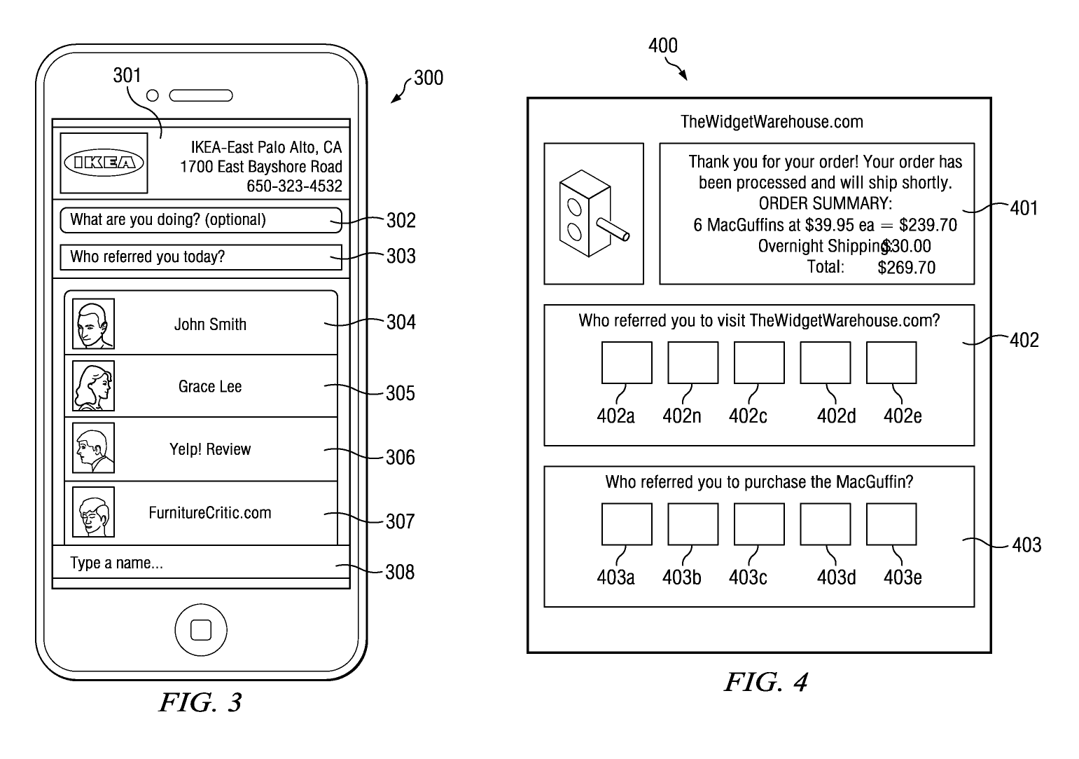

If the merchant code is invalid, at Step 204, the social networking application may display an “invalid code” message to the user. If the code is verified, the social networking system may transmit content, or a universal resource locator (URL) to the content, of a merchant promotion page at Step 205. The merchant promotion page and subsequent steps are discussed further with respect to FIG. 3.

At Step 206, the social networking application displays a selectable list of potentially referring nodes. In particular embodiments, the list is generated by querying, using the graph protocol, any potential connections from the user's first-degree connections to the merchant's node. For example, social networking application may query the social graph in order to determine whether any of the user's connections have interacted with the merchant's hub node through on-network actions, such as “liking” the node, checking-into the node, commenting on the hub page for the node, becoming a fan of the node, or sharing a link to the node on the social networking system. In particular embodiments, the on-network actions may also include implicit connections to the node through natural language processing. For example, if a user mentions or searches for a brand or product without a specific node identification, the social networking system may automatically generate and edge connection between the user node and the merchant's node. In particular embodiments, the social networking application populates the list only with the user's first-degree connections. In particular embodiments, the social networking application may populate the list with any degree of connections or any potential referrer.

In particular embodiments, websites associated with the merchant's node may also transmit browsing and purchase information from online purchases to the social networking system, and the social networking application may query the social graph in order to determine whether any of the user's first-degree connections have interacted with the merchant's hub node through off-network actions, such as visiting the merchant's website, purchasing a product through the merchant's website, adding a product to his or her wishlist on the merchant's website, or writing a review for a product on the merchant's website. As an example, if a user visits a particular “Sports Authority” location and performs the verified check in, the social networking application may display, in order of greatest interaction, a list of the user's friends who have previously purchased products from www.sportsauthority.com, added products to their wishlist on the website, posted a product review on the website, or even frequently viewed www.sportsauthority.com.

In particular embodiments, the social networking system may generate the list of potential referring nodes based upon the user's own browsing history. For example, if the social networking system accesses a particular user's browsing history and determines that the user has visited a review on Yelp.com for the merchant, or a particular blog that has an edge connection to the merchant's node in the social graph, the social networking application may display both the specific Yelp review of the merchant and the blog in the list of potential referrers.

At Step 207, the social networking application receives a user selection designating which of the list of potential referrers actually referred the user to the merchant. In particular embodiments, the social networking application provides an interface that allows the user to type in the name of a particular referrer if it is not displayed in the list displayed in Step 206.

At Step 208, the social networking system updates the account of the referring user and applies one or more policies in response to the updated account. For example, in particular embodiments, the referrer account is merely a count of the number of referrals to the merchant the referrer has made, and the policy is simply to send the referrer a message, such as, “you have currently referred three members to Sports Authority, if you refer two more members, you are eligible to receive a 30% discount on your next purchase.” In particular embodiments, the policy may be adjusted to the merchant's specifications. For example, the merchant may wish to give less of a discount, or require more referrals, etc. This disclosure contemplates applying any suitable policy to the referrer account for each merchant.

FIG. 3 depicts an example user interface for a social networking application residing on a mobile device 300 executing the referral process of FIG. 2. After verifying a merchant code and matching the merchant code to a merchant node on the social network, the user interface may display (in Step 205) merchant page 301. In particular embodiments, merchant page 301 may include various information about the merchant, such as its name, exact location, website, or phone number. In particular embodiments, merchant page 301 may include a logo or map to the physical merchant location. This disclosure contemplates the inclusion, and display of, of any suitable merchant information in merchant page 301.

In particular embodiments, the graphical user interface also includes a status message field 302, that, when populated, is posted on the user's profile page. In particular embodiments, the user may tag or mention other users of the social networking system in status message field 302. In particular embodiments, the social networking system automatically generates a news story for display on the user's profile page, such as, for example, “Grace Lee just referred David White [the user] to IKEA.” In particular embodiments, each of the names of the status message are clickable links that navigate a viewing user to the profile pages of Grace Lee, David White, and the hub page for IKEA, respectively. This disclosure contemplates any suitable use of status message field 302.

The graphical user interface also includes referrer prompt 303, which asks the user to select the user or entity that referred him or her to the merchant from the list of suggested referrers 304-307. The list of referrers 304-307, generated by the social networking system and returned to the social networking application in Step 206, as described above, may include friends of the user on the social network, or sites from the user's own browsing history. For example, users “John Smith” and “Grace Lee” may have edge connections to the merchant's node in the social graph due to “liking” the merchant, posting a review of the merchant, commenting on the merchant's hub page, or interacting with a product node made or sold by the merchant. In particular embodiments, the social networking system suggests possible referrers based on the user's own browsing history. For example, if the user's browsing history shows he or she has recently visited Yelp.com 306 or furniturecritic.com 307, both of which have edge connections between the merchant and their own respective nodes on the social networking system, the social networking application may display links 306 and 307 as potential referrers. In particular embodiments, upon selecting Yelp Review 306, another pop-up menu allows the user to select the specific review or reviewer that influenced his or her decision to visit the merchant. In particular embodiments, the social networking system tracks and correlates each Yelp reviewer to his or her account on the social networking service, and creates an edge from the reviewer's user node to the merchant node in the social networking system. In particular embodiments, the social networking system may utilize implicit edge connections to determine whether a visited web site is a potential referrer. In particular embodiments, the social networking system may utilize natural language processing of URLs to determine whether a particular website is a potential referrer. This disclosure contemplates any suitable method of determining whether a particular user, node, or website is a potential referrer for a particular merchant.

In particular embodiments, social networking application includes a field 308 that permits a user to type in the name of the person or entity that referred him or her to the merchant. This feature may be useful in the scenario where the user is not first-degree connections, or “friends” with the social networking user that referred him or her to the merchant. In particular embodiments, free-form text field 308 permits the user to type in a web address of a specific website from which he or she was referred. In such embodiments, the social networking system may search object database 105 to match the website to a specific user or hub node, and, if one does not exist, may dynamically create a node for the reviewer.

FIG. 4 depicts an example merchant website 400 after a user has completed a transaction. Website 400 contains three main pieces of content, order summary 401, site referral 402, and product referral 403. Only elements 402 and 403 are relevant to this disclosure; the overall content and aesthetics of website 400 and 401 are left to the sole discretion of the merchant. For didactic purposes, website 400 contains only order summary 401, but this disclosure contemplates any manner of content in website 400.

In this particular example, a user has completed a purchase for six “MacGuffin” products at the store, “TheWidgetWarehouse.com,” as reflected in order summary 401. In particular embodiments, website 400 contains code or scripts that communicate with the social networking system's servers to exchange information with the social networking system. In particular embodiments, the merchant website may transmit the user's IP address and purchase information to the social networking website. If the user has logged into the social networking website from the same IP address within a predetermined amount of time, the social networking system can correlate the IP address to a particular social networking ID, and create a log of purchased items. This disclosure does not limit the logging of off-network user actions to purchases; any time a user adds a product to a wishlist, reviews a product, or even browses a product, the action may be logged and stored at the social networking system servers. Subsequently, users who have purchased a given product or visited a particular store may be suggested as referrers for their friends who make purchases at the same store, and so on.

In particular embodiments, the scripts used to communicate with the social networking system servers are JavaScript executed by the visiting user's browser. In particular embodiments, they are social networking system widgets utilizing custom markup language defined by the social networking system. This disclosure contemplates any type of software code or scripting to facilitate communications between a third-party site 123 and the social networking system.

Website 400 includes site referral section 402, which prompts the user to select which of his or her friends or first degree connections referred him to the site, in this case “TheWidgetWarehouse.com.” In particular embodiments, code or scripts in the markup language of website 400 query the social graph for potential referrers of the user. The social networking system generates a list of potential referrers in the same manner as described above, and returns a list of users, or, in particular embodiments, profile photos 402a-402e. The user may select one or more of the users who referred him or her to the website, and the social networking system subsequently updates the referrer's account for the particular site/merchant, and applies one or more referral policies to the referrer account.

Website 400 includes product referral section 403, which prompts the user to select which of his or her friends or first degree connections referred him to the site, in this case “the MacGuffin.” In particular embodiments, code or scripts in the markup language of website 400 query the social graph for potential referrers of the user. The social networking system generates a list of potential referrers in the same manner as described above, and returns a list of users, or, in particular embodiments, profile photos 403a-403e. The user may select one or more of the users who referred him or her to the purchased product, and the social networking system subsequently updates the referrer's account for the particular product manufacturer, and applies one or more referral policies to the referrer account as specified by the manufacturer. It should be evident that multiple product referrer sections 403 may be included on website 400 where the user has purchased more than one type of product. Similarly, it should be evident that the users displayed in section 402 may be the same or different set of users displayed in section 403.

As a result of the data collection of methods and implementations of FIGS. 2-4, the social network is privy to a vast amount of information with regard to the influence of particular nodes on the social networking system. Companies such as Klout and other competitors attempt to determine the social influence of particular users by analyzing the amount of shares or re-shares of a particular piece of content by that user, or the number of click-throughs by other users to a piece of shared content. For further information on calculating social influence, please see commonly-owned U.S. patent application Ser. No. 13/040,129, entitled, “Identify Experts and Influencers in a Social Network,” filed on Mar. 3, 2011 and fully incorporated by reference herein. However, because the aforementioned data collection mechanisms log and track the purchase price resulting from each referral, the present invention permits a social networking system to accurately calculate the aggregate dollar value of a particular referrer.

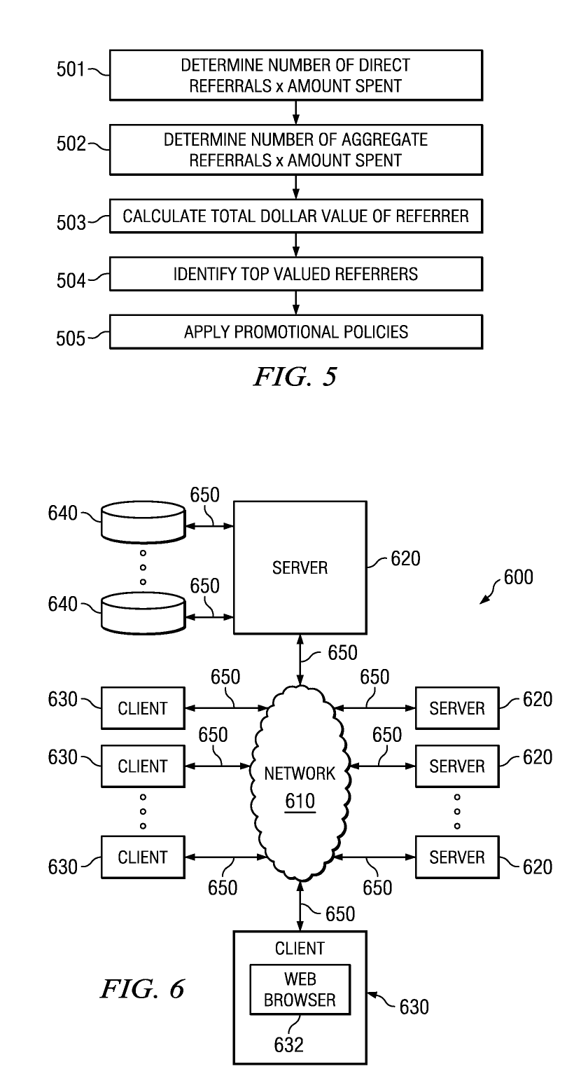

FIG. 5 illustrates one example method of calculating a ranking for any particular referrer for any particular node. For example, if Nike wishes to calculate the top ten referrers for a specific product, such as “Nike Air Zoom Kobe IV” shoes, Nike may specify the node representing the specific product and query the social graph to return all nodes that have referred the specific product, and calculate a total dollar value for each referrer. In particular embodiments, an advertiser may specify larger concept nodes, such as “Nike” and “basketball”, and the social networking system may return all referrers who have referred products having edge connections to both “Nike” and “basketball.” This disclosure contemplates any suitable manner of querying the social graph to ascertain an initial list of referrers.

At Step 501, for a particular referrer, the social networking system determines the number of direct referrals the referrer has made for the specified node or node, and multiplies each referral by the dollar amount of the transaction resulting from the referral. Because the social networking system tracks the dollar amount of each purchase made for each referral, calculating the net revenue gained from the particular referrer's direct referrals is simply a sum-product operation. In particular embodiments, the social networking system also calculates an average revenue/referral value, and stores it with the user. This disclosure contemplates any suitable means of calculating a net-revenue amount resulting from a particular referrer's direct referrals.

At Step 502, the social networking system calculates the net revenue resulting from the referrer's indirect referrals, that is, the sales resulting from referrals from users referred by the referrer. As previously stated, because the social networking system logs and stores the details of every single transaction utilizing the referral program, calculating the net revenue resulting from a set of referrals is simply a sum-product. These indirect referrals can also be considered nth-degree referrals, where n is greater than one. For example, if user A refers three users who make purchases of $10 each, who in turn each refer three users making purchases of $10 each, user A's direct referral revenue is $30, while his indirect referral revenue is $90. In particular embodiments, the social networking system only calculates the second and third degree referrals. In particular embodiments, the issuer of the query, generally the product manufacturer or merchant, may designate how many degrees of referrals he or she wishes to attribute to the initial referrer. In particular embodiments, the value of the referrer may be calculated in terms of virtual currency or credits. For example, a merchant may arbitrarily assign an amount of virtual currency or credits to a particular product so as to reduce the effects of market price fluctuation in determining the value of a referrer.

At Step 503, the social networking system calculates the total dollar value of each referrer by summing the direct revenues and indirect revenues calculated in Steps 501 and 502, respectively. In particular embodiments, direct revenues and indirect revenues are multiplied by weighting coefficients. In particular embodiments, the direct revenues are weighted heavier than indirect revenues. In particular embodiments, the coefficient weight decreases for each degree than N increases, thereby deemphasizing the value of possibly coincidental indirect referrals.

At Step 504, the social networking system generates a list of the top referrers by revenue generated. In particular embodiments, this list may be generated periodically or on demand by a particular node administrator. In particular embodiments, any node administrator may issue a query for any other node; for example, Adidas may wish to determine who the key referrers for Nike products are, and direct promotional items to those referrers. In particular embodiments, Nike itself may wish to determine who are the key referrers for Nike products, and direct promotional items or special offers, such as inviting the referrer to a Nike facility, to the user.

At Step 505, the social networking system may optionally automatically apply one or more specified policies to the top X referrers. For example, a manufacturer may wish to send coupons or free samples at set intervals to the top ten referrers. As another example, a manufacturer may wish to send coupons or invitations to events to high-revenue referrers in the same industry on a monthly basis. This disclosure contemplates allowing individual node administrators to set up any type of automatic policies based on any referrer criteria.

The present invention is not limited to tracking the top dollar referrers for a particular product, brand, or business. In particular embodiments, the social networking system may calculate, based on data collected through the referral program, what businesses, products, or brands are “trending” in the social networking system. For example, the social networking system may determine that particular products have reached a tipping point for virality by tracking the number of purchases of the product. In particular embodiments, the social networking system may anticipate what products, businesses, or brands will likely perform well by tracking other edge actions on object nodes. For example, if information about a particular product has “gone viral,” the social networking system may predict that the sales and revenue for the product will subsequently increase. Similarly, if the virality of a product decreases over time, the social networking system may anticipate that revenues attributed to purchases of the product will decrease. For description into methods of tracking the virality of object nodes, please refer to commonly-owned U.S. patent application Ser. No. 13/229,513, entitled “Understanding Effects of a Communication Propagated Through a Social Networking System,” filed on 9 Sep. 2011 and fully incorporated by reference herein.

In particular embodiments, the social networking system may provide analytics to brand, business, or manufacturer based on both the virality of the node as well as aggregate revenue generated as a result of purchase edges on the node. For example, if a node has “gone viral” (i.e., it is commonly shared, re-shared, and linked on the social networking system), but the product has not generated much in the way of sales, it may indicate that the product is improperly priced. For example, the social networking system may monitor both the virality and aggregate revenue for the node representing “Vibram Fivefingers,” and, if the product is highly viral but low in sales, may suggest to the node administrator (in this case, “Vibram”), that its pricing may be too high. As another example, certain nodes, for example, the object node representing the song “Friday” by Rebecca Black, may have a high degree of virality while having almost zero generated revenue, indicating that the object node is more of an internet meme or joke to be interacted with ironically rather than as a legitimate product. By combining analysis of virality and revenue generation, the social networking system may provide node administrators methods of identifying potential products as well as evaluating the pricing of available product offerings.

In particular embodiments, the virality of a particular object node may be assessed in determining whether a user is actually a “top referrer,” or merely a bandwagon user. For example, if a user has a high number of referrals for products that have a high degree of virality, the social networking system may assume that the referred users would have purchased the product or visited the businesses eventually, regardless of the referral. Conversely, a user who influences other users to make purchase of products that are unpopular and untrendy may be more valuable to a product manufacturer. Thus, in particular embodiments, the social networking system may, either automatically or at the direction of a particular node administrator, rate referrers who generate a large amount of revenue for sales of products having a low virality score higher than referrers who generate a large amount of revenue for sales of products having a high virality score. This disclosure contemplates any suitable method of identifying top referrers.

In particular embodiments, the social networking system may institute a revenue sharing model with the referrer or the brand/merchant. For example, the analytics described above may be offered in exchange for a percentage of revenues resulting from referral on the social networking system. For an example, if user A lists user B as a referrer, but user B did not perform any on-network actions to disseminate his or her endorsement of the merchant/product, the merchant may not pay the social networking system a portion of the revenue of A's transaction. However, if B made an on-network endorsement of the merchant or product, then the social networking system may take a share of the revenue resulting from A's transaction. Similarly, n particular embodiments, the social networking system may implement a revenue sharing model with any number of referrers. For example, either the social networking system or the merchant/brant may share a portion of revenues resulting from referrals with the referrers. This disclosure contemplates any suitable revenue sharing model.

### NETWORK ENVIRONMENT

Particular embodiments may be implemented in a network environment. FIG. 6 illustrates an example network environment 600. Network environment 600 includes a network 610 coupling one or more servers 620 and one or more clients 630 to each other. In particular embodiments, network 610 is an intranet, an extranet, a virtual private network (VPN), a local area network (LAN), a wireless LAN (WLAN), a wide area network (WAN), a metropolitan area network (MAN), a portion of the Internet, or another network 610 or a combination of two or more such networks 610. This disclosure contemplates any suitable network 610.

One or more links 650 couple a server 620 or a client 630 to network 610. In particular embodiments, one or more links 650 each includes one or more wireline, wireless, or optical links 650. In particular embodiments, one or more links 650 each includes an intranet, an extranet, a VPN, a LAN, a WLAN, a WAN, a MAN, a portion of the Internet, or another link 650 or a combination of two or more such links 650. This disclosure contemplates any suitable links 650 coupling servers 620 and clients 630 to network 610.

In particular embodiments, each server 620 may be a unitary server or may be a distributed server spanning multiple computers or multiple datacenters. Servers 620 may be of various types, such as, for example and without limitation, web server, news server, mail server, message server, advertising server, file server, application server, exchange server, database server, or proxy server. In particular embodiments, each server 620 may include hardware, software, or embedded logic components or a combination of two or more such components for carrying out the appropriate functionalities implemented or supported by server 620. For example, a web server is generally capable of hosting websites containing web pages or particular elements of web pages. More specifically, a web server may host HTML files or other file types, or may dynamically create or constitute files upon a request, and communicate them to clients 630 in response to HTTP or other requests from clients 630. A mail server is generally capable of providing electronic mail services to various clients 630. A database server is generally capable of providing an interface for managing data stored in one or more data stores. In particular embodiments, a social-networking system 622 may be hosted on a server 620 (e.g., as a social-networking website). Its users may access social-networking system 622 using their client devices (e.g. clients 630).

In particular embodiments, one or more data storages 640 may be communicatively linked to one or more severs 620 via one or more links 650. In particular embodiments, data storages 640 may be used to store various types of information. In particular embodiments, the information stored in data storages 640 may be organized according to specific data structures. In particular embodiments, each data storage 640 may be a relational database. Particular embodiments may provide interfaces that enable servers 620 or clients 630 to manage, e.g., retrieve, modify, add, or delete, the information stored in data storage 640.

In particular embodiments, each client 630 may be an electronic device including hardware, software, or embedded logic components or a combination of two or more such components and capable of carrying out the appropriate functionalities implemented or supported by client 630. For example and without limitation, a client 630 may be a desktop computer system, a notebook computer system, a netbook computer system, a handheld electronic device, or a mobile telephone. This disclosure contemplates any suitable clients 630. A client 630 may enable a network user at client 630 to access network 630. A client 630 may enable its user to communicate with other users at other clients 630.

A client 630 may have a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 630 may enter a Uniform Resource Locator (URL) or other address directing the web browser 632 to a server 620, and the web browser 632 may generate a Hyper Text Transfer Protocol (HTTP) request and communicate the HTTP request to server 620. Server 620 may accept the HTTP request and communicate to client 630 one or more Hyper Text Markup Language (HTML) files responsive to the HTTP request. Client 630 may render a web page based on the HTML files from server 620 for presentation to the user. This disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

### COMPUTER SYSTEM

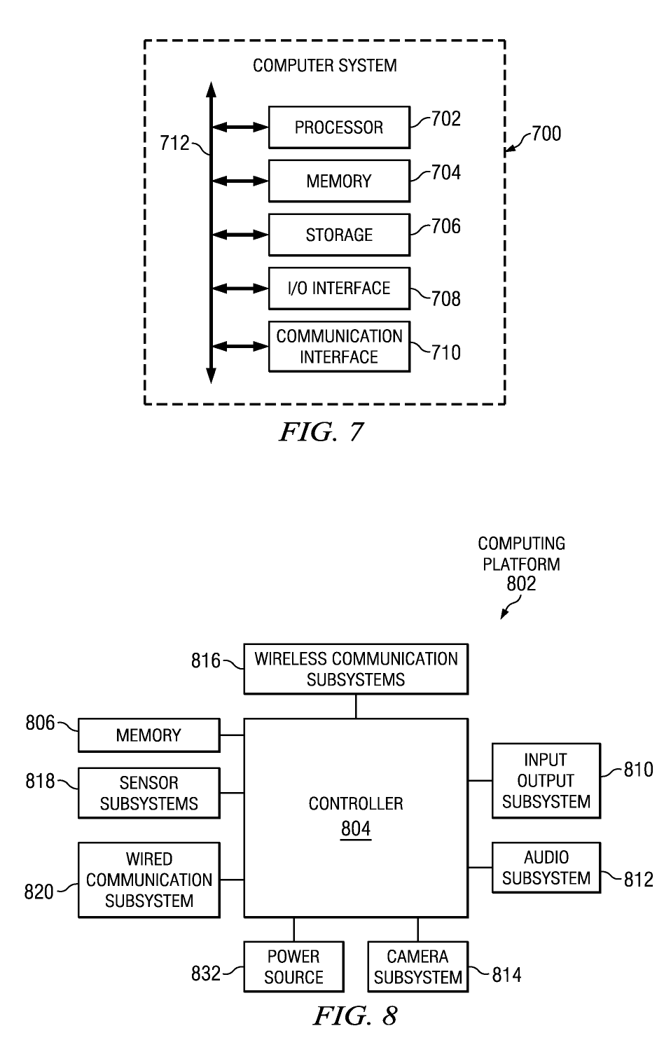

Particular embodiments may be implemented on one or more computer systems. FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 700 may include one or more computer systems 700; be unitary or distributed; span multiple locations; span multiple machines; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include an HDD, a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 702 (such as, for example, one or more internal registers or caches), one or more portions of memory 704, one or more portions of storage 706, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

### MOBILE DEVICE

While mobile device 122 may be implemented in a variety of different hardware and computing systems, FIG. 8 shows a schematic representation of the main components of an example computing platform 802, according to various particular embodiments. Multipoint sensing devices generally include a controller 804 which may comprise a microcontroller or one or more processors configured to execute instructions and to carry out operations associated with a computing platform. Controller 804 may optionally contain a cache memory unit for temporary local storage of instructions, data, or computer addresses. By way of example, using instructions retrieved from memory, controller 804 may control the reception and manipulation of input and output data between components of computing platform 802.

Controller 804 together with a suitable operating system may operate to execute instructions in the form of computer code and produce and use data. The operating system, other computer code (including control client 808 described below) and/or data may be physically stored within a memory block 801 that is operatively coupled to controller 804.

Memory block 801 encompasses one or more storage media and generally provides a place to store computer code (e.g., software and/or firmware) and data that are used by the computing platform 802. By way of example, any of a number of suitable memory cards may be loaded into computing platform 802 on a temporary or permanent basis.

Controller 804 is also generally coupled to a variety of interfaces such as graphics control, video interface, input interface, output interface, and storage interface, and network interface, and these interfaces in turn are coupled to the appropriate devices. In certain embodiments, Controller 804 may connected to an input structure 814 and display 811 may be provided together, such an in the case of a touchscreen where a touch sensitive mechanism is provided in conjunction with the display 811.

Electric signals (e.g., analog) may be produced by microphone 810 and fed to earpiece 812. Controller 804 may receive instruction signals from input structure 814 and control the operation of display 811. Audio signals may be transmitted and received by means of an antenna 818 that may be connected through a radio interface 820 or audio input interface such as microphone 824 to codec 822 configured to process signals under control of controller 804. Additionally, multipoint sensing devices may be powered power source 832.

Mobile device 802 may also include a wireless communication subsystem 816, which may include one or more RF modems for communicating via a number of different protocols, including but not limited to GSM, UMTS, CDMA2000, EDGE, GPRS, global positioning system (GPS), wireless display (WiDi), bluetooth low-energy (BLE), near-field communications (NFC), 802.11 WiFi and 802.16 WiMax, and the like. This disclosure contemplates any suitable wireless communication subsystem 816 for enabling wireless communication with any suitable wireless protocol.

Mobile device may also include one or more user input devices 834 (other than input structure 814) that are operatively coupled to the controller 804. Generally, input devices 834 are configured to transfer data, commands and responses from the outside world into multipoint sensing devices.

Display device 811 is generally configured to display a graphical user interface (GUI) that provides an easy to use visual interface between a user of the computing platform 802 and the operating system or application(s) running on the mobile device.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by one or more computing systems:
receiving, from a user, a data input identifying a particular business;
displaying a list of entities on a social network to the user;
prompting the user to select a referrer from the list of entities;
receiving, from the user, one or more selections identifying one or more entities from the list of entities as a referrer; and
applying one or more policies to the one or more referrers.

2. The method of claim 1, wherein the entities comprise the user's first-degree connections on the social network.

3. The method of claim 2, wherein the entities comprise the user's first-degree connections who have previously interacted with the business on the social network.

4. The method of claim 3, wherein the users who have interacted with the business on the social network are displayed at the top of the list of entities.

5. The method of claim 3, wherein the entities are limited to the users who have interacted with the business on the social network.

6. The method of claim 3, wherein interacting with the business comprises checking-in to the business.

7. The method of claim 3, wherein interacting with the business comprises liking the business.

8. The method of claim 3, wherein interacting with the business comprises adding a product offered by the businesses to a wish list or making a purchase at the business.

9. The method of claim 1, wherein the entities comprise a node on the social network representing web sites that the user has previously visited.

10. The method of claim 1, wherein the one or more policies comprises adding a point to the one or more referrer's account with the particular business.

11. The method of claim 1, wherein the one or more policies comprises sending a message to the one or more referrers, the message indicating how many more referrals the referrer must make in order to receive a promotion.

12. A method comprising, by one or more computing systems:
in response to a first request from a particular user:
requesting, from a remote host, the user identifier for the particular user on a social network, and a list of the users' first-degree connections;
receiving the requested user information from the remote host;
prompting the user to select a referrer from the list of the user's first-degree connections;
receiving, from the user, one or more selections identifying one or more first-degree connections as a referrer; and
applying one or more policies to the one or more referrers.

13. The method of claim 12, wherein the request is a request for content from a universal resource locator, and the prompt comprises a prompt to select which connection referred the user to the universal resource locator.

14. The method of claim 12, wherein the request is a request to purchase a product, and the prompt comprises a prompt to select which connection referred the user to the product.

15. A non-transitory, computer-readable media comprising instructions operable, when executed by one or more computing systems, to:
receive, from a user, a data input identifying a particular business;
display a list of entities on a social network to the user;
prompt the user to select a referrer from the list of entities;
receive, from the user, one or more selections identifying one or more entities from the list of entities as a referrer; and
apply one or more policies to the one or more referrers.

16. The media of claim 15, wherein the entities comprise the user's first-degree connections on the social network.

17. The media of claim 16, wherein the entities comprise the user's first-degree connections who have previously interacted with the business on the social network.

18. The media of claim 17, wherein the users who have interacted with the business on the social network are displayed at the top of the list of entities.

19. A non-transitory, computer-readable media comprising instructions operable, when executed by one or more computing systems, to:
in response to a first request from a particular user:
request, from a remote host, the user identifier for the particular user on a social network, and a list of the users' first-degree connections;
receive the requested user information from the remote host;
prompt the user to select a referrer from the list of the user's first-degree connections;
receive, from the user, one or more selections identifying one or more first-degree connections as a referrer; and
apply one or more policies to the one or more referrers.

20. The media of claim 19, wherein the request is a request to purchase a product, and the prompt comprises a prompt to select which connection referred the user to the product.
